(19) United States
(12) Patent Application Publication
(10) Pub. No.: US 2014/0373082 A1
(43) Pub. Date: Dec. 18, 2014

(54) OUTPUT SYSTEM, CONTROL METHOD OF OUTPUT SYSTEM, CONTROL PROGRAM, AND RECORDING MEDIUM

(71) Applicant: Sharp Kabushiki Kaisha, Osaka (JP)

(72) Inventors: Akiko Miyazaki, Osaka (JP); Kohji Fujiwara, Osaka (JP); Tomohiro Kimura, Osaka (JP); Toshiharu Kusumoto, Osaka (JP)

(73) Assignee: Sharp Kabushiki Kaisha, Osaka (JP)

(21) Appl. No.: 14/376,062

(22) PCT Filed: Jan. 30, 2013
(86) PCT No.: PCT/JP2013/052018

§ 371 Date: Jul. 31, 2014

(30) Foreign Application Priority Data
Feb. 3, 2012 (JP) 2012-022463

(51) Int. Cl. H04N 21/462; H04N 21/441; H04N 21/81; H04N 21/4415; H04N 21/44; H04N 21/8405; H04N 21/41; H04N 21/45

(52) U.S. Cl. CPC H04N 21/4622; H04N 21/4126; H04N 21/441; H04N 21/4532; H04N 21/4415; H04N 21/44008; H04N 21/8405; H04N 21/8133
USPC 725/110

(57) ABSTRACT

A display system (100) includes a television receiver (110a) and a smartphone (110b). The television receiver (110a) is provided with a display unit (51a) for outputting content and a keyword detector (15) for extracting keywords (1) from the content. The smartphone (110b) is provided with a keyword selector (16) and a keyword-related information acquisition unit (17) that extract the related information (2) acquired from the outside that is related to the keywords (1) selected by the user from among the keywords (1) extracted by a keyword detector (15), and a display unit (51b) for outputting the keywords (1) and the related information (2).

### TECHNICAL FIELD

The present invention is related to an output system that outputs content.

### BACKGROUND ART

Recently, technology for detecting keywords (character strings) in content is widely used. In Patent Document 1 below, a device that detects keywords from a conversation within a video is disclosed, for example. Also, in Patent Document 2 below, a device that detects keywords that match the taste and interest of a user is disclosed, for example.

A conventional display device that displays detected keywords along with content will be described based on FIG. 16. FIG. 16 is a schematic view of a conventional display device displaying content and keywords overlapping. As shown in FIG. 16, other widely used display devices suggest keywords that were detected using the conventional technology mentioned above along with content to help users acquire additional information related to the keywords.

### RELATED ART DOCUMENTS

### Patent Documents

Patent Document 1: Japanese Patent Application Laid-Open Publication No. 2011-49707 (Published on Mar. 10, 2011)

Patent Document 1: Japanese Patent Application Laid-Open Publication No. 2010-55409 (Published on Mar. 11, 2010)

### SUMMARY OF THE INVENTION

### Problems to be Solved by the Invention

As shown in FIG. 16, displaying keywords in a conventional display device inhibits displaying content, because the content and keywords are shown together overlapping, the display size of the content is reduced, and the like. The resulting problem is that when a user displays keywords, the user cannot comfortably watch the content.

Another problem of the conventional display device is that the calculation load not only to detect keywords but also to perform the process to acquire information related to the keywords is solely concentrated in the display device.

The above-mentioned Patent Documents 1 and 2 only focus on extracting keywords from content and do not disclose a technology or a configuration that can solve the problems mentioned above.

The present invention takes into account the above-mentioned problems, and an aim thereof is to provide an output system or the like that improves convenience for the user by suggesting keywords (character strings) to the user without inhibiting the output of the content.

### Means for Solving the Problems

In order to solve the above-mentioned problems, an output system according to an embodiment of the present invention

(1) is an output system that outputs content, including

(2) a first output device and a second output device,

(3) wherein the first output device includes:

(3a) a first output part that outputs the content; and

(3b) an extraction part that extracts character strings from the content outputted by the first output part,

(4) wherein the second output device includes:

(4a) an acquisition part that acquires information from outside related to a character string selected by a user from the character strings extracted by the extraction part; and

(4b) a second output part that outputs the character string and information related to the character string acquired by the acquisition part.

Also, in order to solve the above-mentioned problems, a control method for an output system according to an embodiment of the present invention includes:

(1) a first output device and a second output device that output content;

(2) a first output step that outputs the content;

(3) an extraction step in which a character string is extracted from information included in the content outputted by the first output step;

(4) an acquisition step in which information related to a character string selected by a user from the character string extracted by the extraction step is acquired from outside; and

(5) a second output step in which the character string and the information acquired by the acquisition step and related to the character string is outputted.

### Effects of the Invention

An output system related to an embodiment of the present invention and a control method for the output system can suggest character strings to users through a second output device without inhibiting the output of content by a first output device.

Furthermore, the second output device can concentrate on acquiring information related to a character string because the first output device detects keywords from content and the second output device does not need to detect character strings. In other words, the calculation load is distributed. Thus, the output system or the like related to an embodiment of the present invention includes a second output device that can smoothly acquire related information even if the computational resources of the second output device is insufficient.

Additionally, the user can acquire information related to character strings by simply selecting the character strings outputted by the second output device. As a result, an output system and the like related to an embodiment of the present invention also allows the user to instantly acquire related information without inputting character strings.

### BRIEF DESCRIPTION OF THE DRAWINGS

FIG. 1 is a block diagram of Embodiment 1 of the present invention, showing the configuration of main components of a display system that includes a television receiver and a smartphone.

FIG. 2 is a schematic view of examples of an external appearance for the display system and a display screen for the smartphone shown in FIG. 1, in which FIG. 2(a) shows the external appearance and FIG. 2(b) shows the display screen with keywords on the smartphone.

FIG. 3 is a schematic view showing different configurations of the display panel shown in FIG. 1, in which FIG. 3(a) is an example of a system with two display units formed in integration, and FIG. 3(b) shows a system in which the television receiver and smartphone shown in FIG. 1 are connected by wire.

FIG. 4 is a schematic view that shows the process of detecting keywords by the television receiver shown in FIG. 1; FIG. 4(a) shows content being outputted to the television receiver, FIG. 4(b) shows the process in which the text information converted from sound information is broken down to parts of speech, and FIG. 4(c) shows keywords 1 shown in FIG. 1 being displayed on the smartphone shown in FIG. 1.

FIG. 5 is a schematic view of an example of a display screen of the smartphone shown in FIG. 1 displaying keywords; FIG. 5(a) is an example of a display screen showing the keywords and other information, FIG. 5(b) shows how keywords that were detected earlier are stored one after another into the keyword storage folder, and FIG. 5(c) is an example of a display screen for when a user selects multiple keywords and starts searching.

FIG. 6 is a flowchart showing an example of steps executed by the television receiver and the smartphone shown in FIG. 1.

FIG. 7 is a block diagram of Embodiment 2 of the present invention, showing the configuration of main components of a display system that includes a television receiver and a smartphone.

FIG. 8 is a schematic view of an example of a display screen in which the smartphone shown in FIG. 7 displays metadata in addition to keywords.

FIG. 9 is a flowchart showing an example of steps executed by the television receiver and the smartphone shown in FIG. 7.

FIG. 10 is a block diagram of Embodiment 3 of the present invention, showing the configuration of main components of a display system that includes a television receiver and a smartphone.

FIG. 11 is a schematic view showing an example of steps executed by the television receiver shown in FIG. 10.

FIG. 12 is a flowchart showing an example of steps executed by the television receiver and the smartphone shown in FIG. 10.

FIG. 13 is a block diagram of Embodiment 4 of the present invention, showing the configuration of main components of a display system that includes a television receiver and a smartphone.

FIG. 14 is a schematic view of an example of a display screen shown in FIG. 13 displaying keywords.

FIG. 15 is a flowchart showing steps executed by the television receiver and the smartphone shown in FIG. 13.

FIG. 16 is a schematic view of a conventional display device displaying content and keywords overlapping.

### DETAILED DESCRIPTION OF EMBODIMENTS

### Embodiment 1

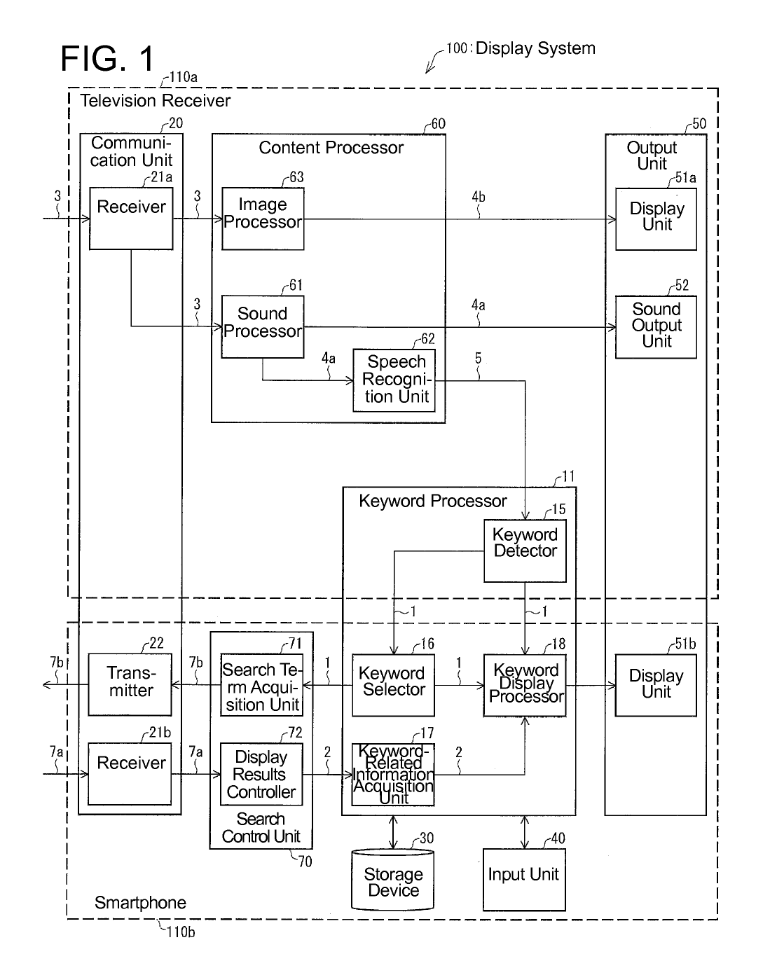

Below, Embodiment 1 of the present invention will be described in detail with reference to FIGS. 1 to 6.

### Summary of Display System 100

An overview of a display system 100 related to the present embodiment will be described with reference to FIG. 1. FIG. 1 is a block diagram showing the configuration of the main parts of the display system 100. The display system (output system) 100 is a system that outputs content, and the system includes a television receiver (first output device) 110a and a smartphone (second output device) 110b.

The television receiver 110a outputs the content and also sends the keywords (character strings) 1 detected from the content to the smartphone 110b. The smartphone 110b outputs the keywords 1 sent from the television receiver and related information (information related) to keywords 1.

Here, “content” refers to a television program acquired by the television receiver 110a (display system 100) receiving a broadcast from a broadcasting station (including the main channel and the sub-channel) outside in real-time. The content has sound information 4a and video information 4b, and may also have metadata 9. However, the content may be any or all of a video, an image, music, sound, writing, a character, a formula, a number, and a symbol provided by terrestrial broadcasting, cable television, CS broadcasting, radio broadcasting, internet, and the like.

In addition, “metadata” is data including information to identify the content. Metadata includes: data information, EPG information, present program information, various data and the like acquired through the internet, and the like.

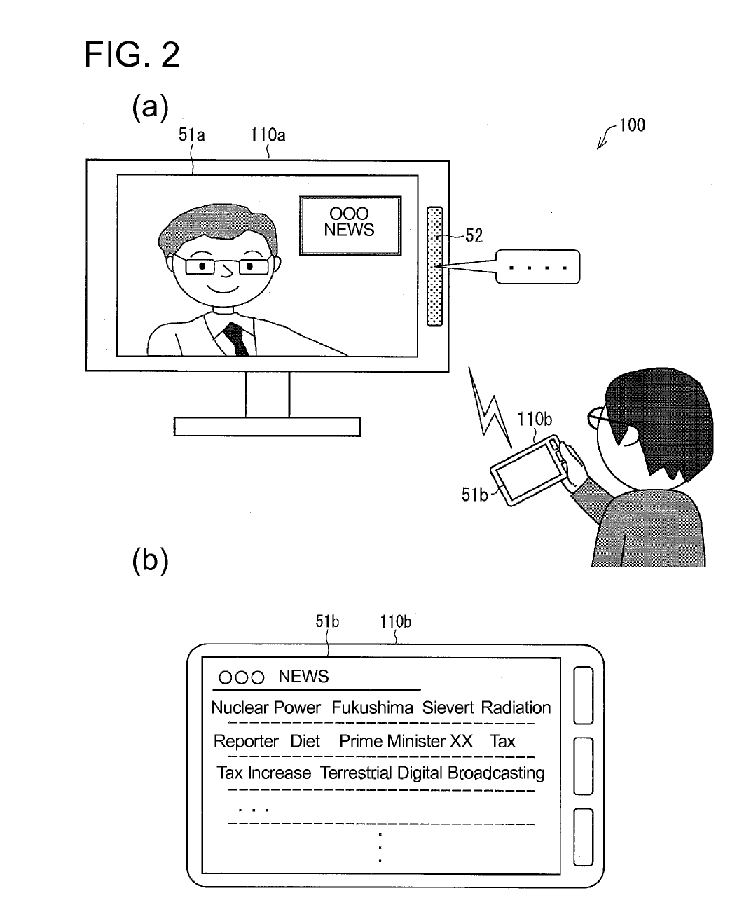

A use aspect and an external appearance of a display system 100 related to the present embodiment will be described with reference to FIG. 2. FIG. 2 is a schematic view of an example of an external appearance of the display system 100 and an example of a display screen of the smartphone 110b; FIG. 2(a) shows the external appearance of the display system 100, and FIG. 2(b) shows the keywords 1 displayed on the display screen of the smartphone 110b.

As shown in FIG. 2(a), the television receiver 110a simultaneously outputs content to a user through a display unit (first output unit) 51a, and sends keywords 1 detected (a character string extracted) from the content to the smartphone 110b.

As shown in FIG. 2 (b), each time the smartphone 110b receives a keyword 1 from the television receiver 110a, the smartphone outputs the keyword to a display unit (the second output unit) 51b. In other words, the smartphone 110b outputs the keyword 1 detected by the television receiver 110a in real time. Also, if a user selects a keyword 1, the smartphone 110b acquires related information 2 associated with the keyword from outside (through the internet, for example), and outputs the related information 2 to the display unit 51b.

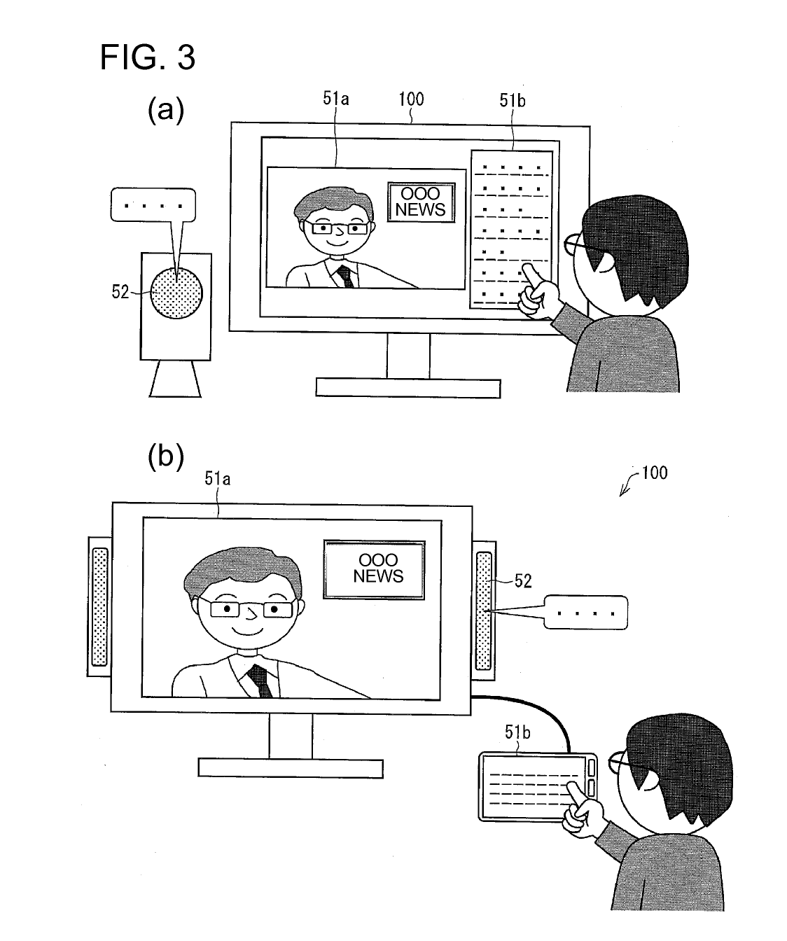

A use aspect and an external appearance of a display system 100 related to the present embodiment will be described with reference to FIG. 3. FIG. 3 is a schematic view showing different configurations of the display system 100, in which FIG. 3(a) shows an example of a system with the display unit 51a and the display unit 51b formed in integration, and FIG. 3(b) shows a system in which the television receiver 110a and the smartphone 110b are connected by wire.

As shown in FIG. 3(a), the display system 100 may be one device in which the display unit 51a and the display unit 51b are integrally formed. In other words, the display system (output device) 100 outputs the content to the main display (display unit 51a, first output unit), and outputs keywords 1 to the sub-display (display unit 51b, second output unit).

The television receiver 110a and smartphone 110b may be connected by wire in the display system 100 shown in FIG. 3(b). As explained for the smartphone 110b, when a user selects a keyword 1 from the keywords 1 displayed in the display unit 51b, the display system 100 acquires related information 2 associated with the keyword from outside, and outputs the related information 2 to the display unit 51b.

Below, the display system 100 will be described as a system that includes a television receiver 110a and a smartphone 110b that can communicate with each other through wireless connection. However, the embodiments of the display system 100 are not limited to the examples shown in FIGS. 2(a), 3(a), and 3(b). For example, for the display system 100, a personal computer may be used instead of the television receiver 110a, and a tablet PC or a remote controller with a display may be used instead of the smartphone 110b.

Meanwhile, the block diagram in FIG. 1 does not specify that the display system 100 is formed of two devices separated from each other: the television receiver 110a and the smartphone 110b. (1) The display system 100 of the present embodiment can be realized as one device as shown in FIGS. 3(a), and (2) according to known devices and methods, it is easy to realize the display system 100 related to the present embodiment as two separate devices that can communicate with each other.

Also, the communication between the television receiver 110a and smartphone 110b is not limited to communication line, communication method, communication medium, or the like. An IEEE802.11 wireless network, Bluetooth (registered trademark), NFC (near field communication), and the like can be used as a communication method or communication medium, for example.

### Configuration of Display System 100

The configuration of a display system 100 related to the present embodiment will be described with reference to FIG. 1. In addition, parts that are not directly related to the present embodiment are not shown in the explanation of the configuration and the block diagram for ease of description. However, the display system 100 related to the present embodiment may include a simplified configuration depending on the actual situation regarding the embodiment. Also, the two portions surrounded by dotted lines in FIG. 1 shows the configurations of the television receiver 110a and smartphone 110b.

The respective components included in the display system 100 may be realized as hardware by using a logic circuit formed on an integrated circuit chip (IC chip), or the display system may be realized as software by having a CPU (central processing unit) execute a program stored in a storage device such as RAM (random access memory) or flash memory. The respective configurations are explained in detail below.

(Configuration of Television Receiver 110a)

The television receiver 110a includes: a communication unit 20 (receiver 21a), a content processor 60 (sound processor 61, speech recognition unit 62, image processor 63), an output unit 50 (display unit 51a, sound output unit 52), and a keyword processor 11 (keyword detector 15).

The communication unit 20 communicates with the outside through a network using a prescribed communication method. The communication unit only needs to be provided with basic features that allow communication with external devices, receive television broadcasting, and the like, and is not limited by the broadcast format, communication line, communication method, communication medium, and the like. The communication unit 20 includes: a receivers 21a and 21b, and a transmitter 22. However, the communication unit 20 of the television receiver 110a includes a receiver 21a, and the communication unit 20 of the smartphone 110b includes a receiver 21b and a transmitter 22.

The receiver 21 a outputs a content stream 3 received from outside to a sound processor 61 and an image processor 63. The content stream 3 is any data that includes content, which can be a digital television broadcasting signal, for example.

The content processor 60 processes the content stream 3 inputted from the receiver 21a. The content processor 60 includes: a sound processor 61, a speech recognition unit 62, and an image processor 63.

The sound processor 61 separates the sound information (content, sound) 4a of the content stream 3 inputted from the receiver 21a that corresponds to the user selected broadcasting station, and outputs the information to the speech recognition unit 62 and the sound output unit 52. The sound processor 61 may change the volume of the sound of the sound information 4a or change the frequency characteristics of the sound, by altering the sound information 4a.

The speech recognition unit (extraction part) 62 sequentially recognizes the sound information 4a inputted in real time from the sound processor 61, converts the sound information 4a into text information 5, and outputs the text information 5 into a keyword detector 15. For the above-mentioned recognition and conversion, a widely known speech recognition technology can be used.

The image processor 63 separates the video information (content, video) 4b that corresponds to the user selected broadcasting station of the content stream 3 inputted from the receiver 21a, and outputs the information to the display unit 51a. By modifying the video information 4b, the image processor 63 may execute similar extension or similar reduction (scaling) and modify at least one of the following: brightness, sharpness, and contrast.

The output unit 50 outputs the sound information 4a and the video information 4b. The output unit 50 includes display units 51a and 51b, and a sound output unit 52. However, the output unit 50 of the television receiver 110a includes a display unit 51a and a sound output unit 52, and the output unit 50 of the smartphone 110b includes a display unit 51b.

The display unit (first output unit) 51a displays the video information 4b inputted from the image processor 63. In the present embodiment, it is assumed that the display unit 51a is a liquid crystal display (LCD), but it should be noted that as long as the display unit 51a is a device (especially, a flat panel display) with a display function, the type of hardware used is not limited to LCDs. The display unit 51a can be constituted of a device or the like provided with a driver circuit that drives the display element, based on the video information 4b and a display element such as a plasma display panel (PDP) or an electroluminescence (EL) display.

The sound output unit (first output unit) 52 converts the sound information 4a inputted from the sound processor 61 into sound waves and outputs the sound waves to the outside of the sound output unit. Specifically, the sound output unit 52 may be a speaker, an earphone, a headphone, or the like. If a speaker is used as the sound output unit 52, the television receiver 110a may have an embedded speaker, or an external speaker connected to an external connection terminal, as shown in FIGS. 2 and 3.

The keyword processor 11 processes the keywords 1 included in the text information 5. The keyword processor 11 includes a keyword detector 15, a keyword selector 16, a keyword-related information acquisition unit 17, and a keyword display processor 18. In the present embodiment, the keyword processor 11 of the television receiver 110a includes a keyword detector 15, and the keyword processor 11 of the smartphone 110b includes a keyword selector 16, a keyword-related information acquisition unit 17, and a keyword display processor 18. However, a portion or all of the keyword processor 11 may be included in the smartphone 110b.

The keyword detector (extraction part) 15 detects a keyword 1 from the text information 5 inputted from the speech recognition unit. Here, the keyword detector 15 may store the detected keyword 1 in the storage device 30 (or other storage devices not shown in FIG. 1). The specific detection method of the keyword detector 15 for the keyword 1 will be described in detail later. Also, the keyword detector 15 may include a transmitting function (transmitting device, transmitting part) to send the keyword 1 to a smartphone 110b. However, if the display system 100 is realized as one device, the above-mentioned transmitting function is unnecessary.

(Configuration of Smartphone 110b)

The smartphone 110b includes a communication unit 20 (receiver 21b, transmitter 22), a search control unit 70 (search term acquisition unit 71, result display controller 72), a keyword processor 11, a keyword selector 16, a keyword-related information acquisition unit 17, a keyword display processor 18), an output unit 50 (display unit 51b), an input unit 40, and a storage device 30.

The receiver 21b receives the search result 7a through any transmission path, and outputs the search result to the result display controller 72.

The transmitter 22 sends the search command 7b inputted from the search term acquisition unit 71 through any transmission path. The search command 7b may be sent anywhere as long as the receiver can receive the search command 7b and respond; the receiver can be a search engine in the internet or a database server in an intranet, for example.

Also, the receiver 21b and the transmitter 22 can be constituted of an Ethernet (registered trademark) adapter. In addition, IEEE802.11 wireless network, Bluetooth (registered trademark), and the like may be used as a communication method or a communication medium.

The search control unit 70 processes the search result 7a inputted from the receiver 21b. The search control unit 70 includes a search term acquisition unit 71 and a result display controller 72.

The search term acquisition unit 71 converts the keyword 1 inputted from the keyword selector 16 into a search command 7b and outputs the command to the transmitter 22. Specifically, if a smartphone 110b requests a search result 7a to a particular search engine in the internet, for example, the search term acquisition unit 71 outputs a search command 7b to the transmitter 22, in which the search command 7b is a character string with a search query to search for the keyword 1 added after the address of the search engine. Otherwise, if the smartphone 110b requests a search result 7a to a database server in an intranet, for example, the search term acquisition unit 71 outputs a database control command to search for the keyword 1 as a search command 7b to the transmitter 22.

The result display controller 72 converts the search result 7a inputted from the receiver 21b into related information 2, and outputs the information to the keyword-related information acquisition unit 17. For the result display controller 72, the top three most related search results 7a may be the related information 2, or an image extracted from the search result 7a may be the related information, for example. Otherwise, the result display controller 72 may use the recommended information predicted from the search result 7a as the related information, or use the search result 7a itself (no changes made to the search result 7a) as the related information 2.

The keyword selector (acquisition part) 16 outputs the keyword 1, selected by the user from among the keywords 1 (sent from the television receiver 110a) inputted from the keyword detector 15, to the search term acquisition unit 71. More specifically, the keyword selector 16 identifies the keyword 1 selected by the user based on the coordinate information inputted from the input unit 40, and outputs the keyword to the search term acquisition unit 71.

From outside, the keyword-related information acquisition unit (acquisition part) 17 acquires related information 2 associated with the keyword 1 selected by the user from among the keywords 1 inputted (sent from the television receiver 110a) from the keyword detector 15 through a receiver 21b and a result display controller 72. The keyword-related information acquisition unit (acquisition part) 17 outputs the acquired related information 2 to the keyword display processor 18.

The keyword display processor (second output part) 18 outputs the keywords 1 sequentially inputted by the keyword detector 15 and the related information 2 from the keyword-related information acquisition unit 17 to the display unit 51b. Specifically, as will be discussed later in a display example of a keyword 1, the keyword display processor 18 sequentially switches the keyword 1 and outputs it in real time as the television receiver 110a outputs the content to the display unit 51a.

Also, the keyword selector 16 and the keyword display processor 18 may include a receiving function (receiving device, receiver) to receive the keyword 1 sent from the television receiver 110a. However, if the display system 100 is realized as one device, the above-mentioned receiving function is unnecessary.

Furthermore, the keyword display processor 18 can determine where the keyword 1 is arranged in the display unit 51b so as to make the display easy to see for the user. Furthermore, the keyword display processor 18 can display information other than the keyword 1 and the related information 2.

A storage device 30 is a non-volatile storage device that that can store keywords 1, related information 2, and the like. The storage device 30 may be a hard disk, a semiconductor memory, a DVD (digital versatile disk), or the like. Also, while the storage device 30 is shown as a device embedded in the smartphone 110b (display system 100) in FIG. 1, the storage device may be an external storage device that is connected to the smartphone 110b externally such that the storage device and the smartphone 110b can communicate with each other.

The input unit 40 receives touch operations by the user. In the present embodiment, the touch panel is assumed to be able to detect multi-touch. However, as long as the input unit 40 has an input surface where the user can input information through touch operation, the type of hardware used is not limited. The input unit 40 outputs the two-dimensional coordinate information from an input tool such as a user's finger or a stylus being in contact with the input surface to the keyword processor 11.

The display unit (second output part) 51b displays a keyword 1 that is inputted from the keyword display processor 18 and related information 2 inputted from the keyword-related information acquisition unit 17. The display unit 51b can be configured in a manner similar to the display unit 51a using appropriate devices such as a liquid crystal display.

FIG. 1 shows a configuration in which the input unit 40 is separated from the display unit 51b in order to clearly indicate the function of each component. However, if the input unit 40 is a touch panel and the display unit 51b is a liquid crystal display, for example, then it is preferable that the input unit and the display unit be configured as one component (refer to FIG. 2(a)). In other words, the input unit 40 is configured so as to include a data input surface made of a transparent member such as glass formed in a rectangular plate shape, and the input unit may be formed so as to cover the entire data display surface of the display unit 51b. As a result, the users can make inputs naturally because the contact area where the input unit and the like touch the input surface of the input unit 40 matches the display position of the figures and the like displayed in the display unit 51b in response to the contact.

(Process of Detecting Keyword in Keyword Detector 15)

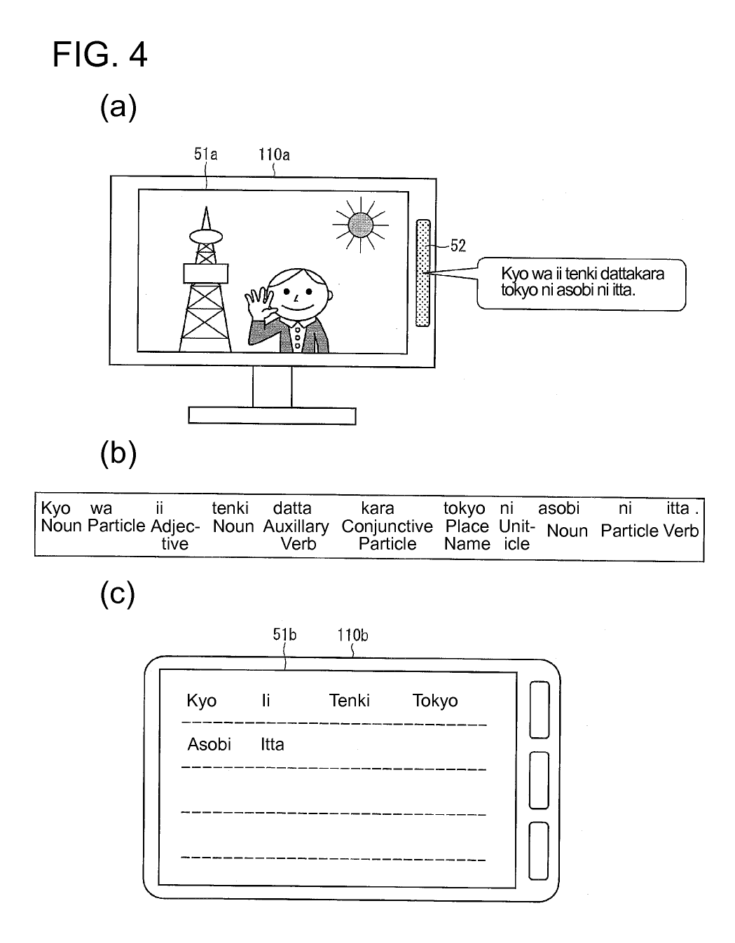

The process of detecting a keyword 1 executed by the keyword detector 15 (refer to FIG. 1, and so forth) will be described based on FIG. 4. FIG. 4 is a schematic view of the steps in the above-mentioned detecting process; FIG. 4(a) shows a content (television program) shown through the television receiver 110a, FIG. 4(b) shows the process in which the text information 5 converted from sound information 4a is broken down into parts of speech, and FIG. 4(c) shows the keyword 1 being displayed on the smartphone shown in FIG. 1.

As shown in FIG. 4(a), the assumption is that the content includes sound information 4a that says “kyo wa ii tenki dattakara tokyo ni asobi ni itta.” As mentioned before, the speech recognition unit 62 converts the sound information 4a into text information 5 by recognizing the sound information 4a. This conversion is executed in synchronization with (in other words, in real time) the sound processor 61 and the image processing unit 63 outputting content to the sound output unit 52 and the display unit 51a.

Also, if the television receiver 110a is provided with a storage device (not shown in FIG. 1), then the speech recognition unit 62 may store the text information 5 acquired by recognizing the sound information 4a in the storage device.

As shown in FIG. 4(b), the keyword detector 15 breaks down the text information 5 into parts of speech. Known parsing methods can be used for the process of breaking down the text information into parts of speech. Next, the keyword detector 15 detects the keyword 1 from the text information 5 based on a prescribed standard. The keyword detector 15 may detect a keyword 1 by excluding ancillary words (parts of speech that cannot form a phrase on their own such as postpositional particles or auxiliary verbs in Japanese and prepositions in English) and extracting only independent words (parts of speech that can form a phrase on their own such as nouns and adjectives), for example. This detection is executed in synchronization (in other words, in real-time) with the sound processor 61 and the image processing unit 63 outputting content to the sound output unit 52 and the display unit 51a, respectively.

Furthermore, the keyword detector 15 may prioritize the keywords 1 detected based on the prescribed standard. The keyword detector 15 can give higher priority to a keyword 1 that the user sets as an important keyword, or a keyword 1 that has been searched in the past. Otherwise, the keyword detector 15 can prioritize the keywords according to the time when the keyword 1 was detected (hereinafter, “time stamp”) or the number of times the word was detected.

As shown in FIG. 4(c), the keyword 1 detected by the keyword detector 15 is displayed on the display unit 51b by the keyword display processor 18. As mentioned before, the speech recognition unit 62 and the keyword detector 15 simultaneously recognize the sound information 4a and detect the keyword 1 as the television receiver 110a outputs the content, and thus the keyword display processor 18 can output and switch the keyword 1 in real time as the television receiver 110a outputs the content. Furthermore, the keyword display processor 18 can determine the design and where the keyword 1 is arranged in the display unit 51b so as to make the display easy to see for the user.

(Storing Detected Keyword 1 into Storage Device 30)

As mentioned before, the keyword detector 15 (refer to FIG. 1, the same hereinafter) may store the keyword 1 into the storage device 30 (or other storage devices not shown in FIG. 1). Here, the keyword detector 15 may store the keyword 1 in the storage device associated with a time stamp. As a result, the user or the display system 100 can refer to the keyword 1 using the date and time as a key, which can result in better accessibility to the keyword 1.

Also, the keyword detector 15 can specify the period during which the keyword 1 is stored in the storage device, and can delete the keyword from the storage device after the specified period has passed. The keyword detector 15 can specify the period by specifying the date and time corresponding to the end of the period, or it can specify the period as a period of time after the time and date during which the keyword was searched. As the keyword detector 15 deletes old keywords 1 one after another, a state in which new keywords 1 are stored in the storage device is maintained. Also, the storage capacity is not unnecessarily consumed.

As mentioned before, if the keyword detector 15 prioritizes the keywords 1, the keyword detector 15 may decide on the storing period for the keywords 1 according to their priority level. As a result, the keyword detector 15 can keep a keyword 1 with high priority for a long period of time, for example.

The keyword detector 15 can save the detected keyword 1 in both the television receiver 110a and the smartphone 110b. In this case, the keyword detector 15 can make the storing period of either one longer or shorter than the other.

Otherwise, the keyword detector 15 may save the keyword 1 in just one of the television receiver 110a or the smartphone 110b. As a result, saving multiple copies of the keyword 1 as described above can be avoided. Furthermore, if the keyword processor 11 (or other members included in the keyword processor 11) is provided with an independent memory, then the keyword detector 15 may store the keyword 1 in that memory.

### Example of Display Showing Keyword 1 in Smartphone 110b

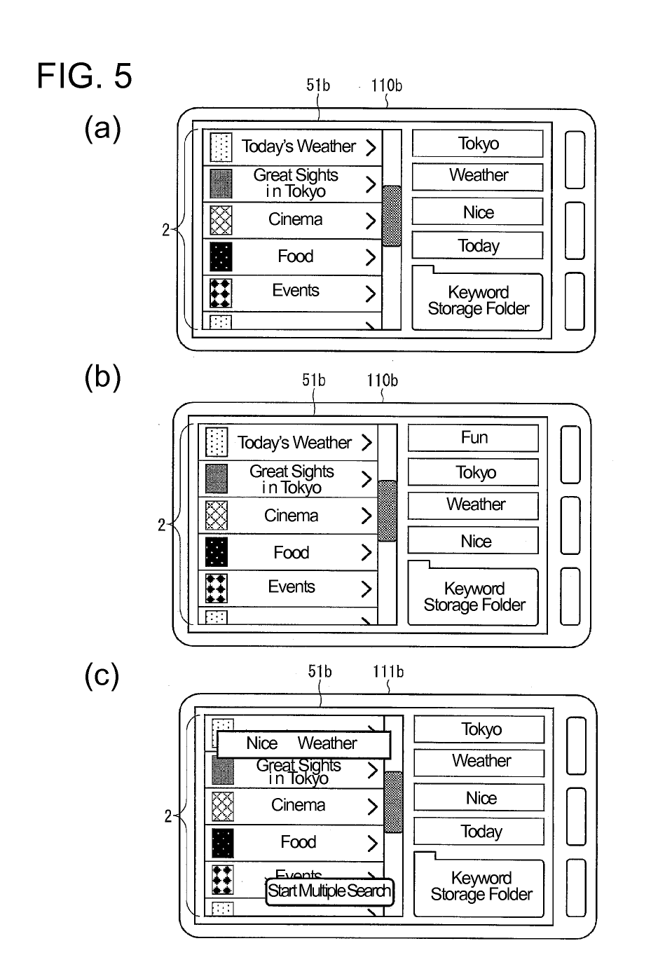

Based on FIG. 5, an example of a display showing a keyword 1 in a smartphone 110b will be described. FIG. 5 is a schematic view of an example of the smartphone 110b displaying the keyword 1, in which FIG. 5(a) shows an example where the keyword 1 is shown along with other information, FIG. 5(b) shows an example where a keyword 1 that was searched a while ago is stored into the keyword storage folder one after another, and FIG. 5(c) shows an example where the user selected multiple keywords 1 to search.

As shown in FIG. 5(a), the keyword display processor 18 (refer to FIG. 1; the same applies hereinafter), can show the keyword 1 and the related information 2 in the display unit simultaneously. In FIG. 5(a), related information 2 associated with the detected keyword 1 such as “today's weather” and “great sights in Tokyo” are shown in the left-hand column of the display unit 51b.

As mentioned above, the keyword selector 16 detects the user selecting a keyword 1, and the keyword-related information acquisition unit 17 acquires the related information 2 associated with the keyword. As a result, if the user selects “Tokyo,” for example, the keyword display processor 18 can show information related (related information 2) to “Tokyo” in the display unit 51b.

As shown in FIG. 5(b), the keyword display processor 18 stores in the keyword storage folder a keyword 1 in which a long time elapsed since the keyword was last detected. In other words, the keyword display processor 18 keeps old keywords 1 in the keyword storage folder and does not show the keyword so that the old keywords 1 do not occupy the space needed to output a newly detected keyword. In FIG. 5(b), an old keyword “Today” is stored in the keyword storage folder and a new keyword “Fun” is shown instead.

As a result, the user interface can be improved by preferentially displaying sequentially detected new keywords 1 in parallel with (in coordination with) the progress in the content outputted by the television receiver 110a.

Also, it should be noted that the above-mentioned “in parallel with (in coordination with) the progress in the content outputted,” includes a prescribed time lag between “displaying the keyword 1” and “outputting the content.” In addition, the keyword display processor 18 may display a sliding effect for the keyword when the old keyword 1 is being stored into the folder.

As shown in FIG. 5(c), if the user selects a plurality of keywords 1, the keyword selector 16 can output all of the keywords to the search term acquisition unit 71. As a result, the keyword-related information acquisition unit 17 can obtain related information 2 for all (AND search) or one (OR search) of the keywords.

### Process Executed by Television Receiver 110a and Smartphone 110b

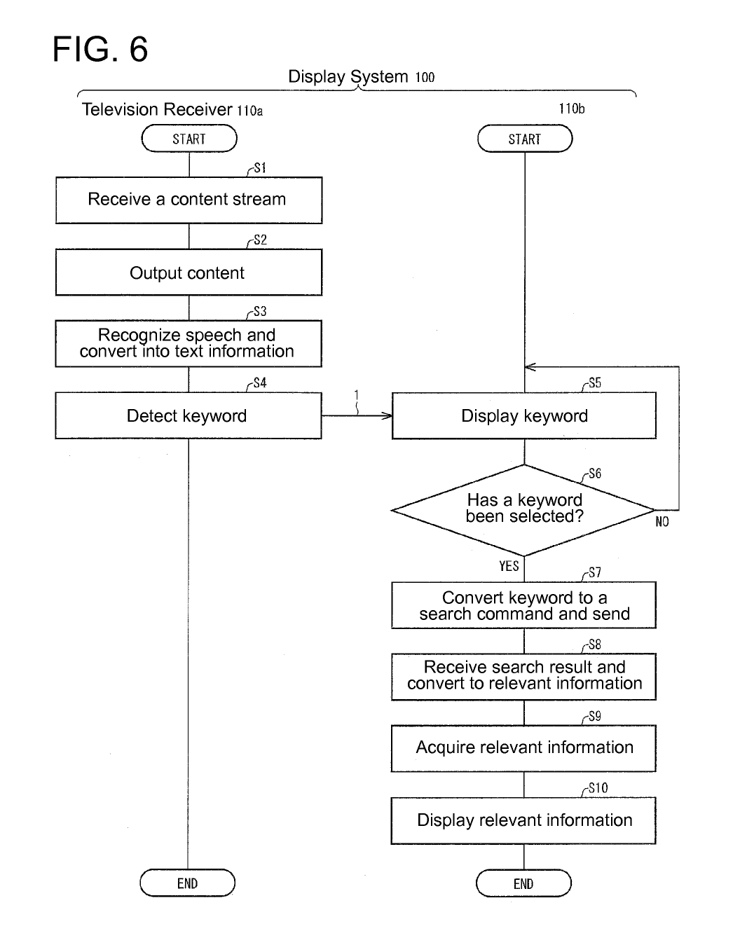

Based on FIG. 6, the flow of the process executed by the television receiver 110a and the smartphone 110b will be explained. FIG. 6 is a flowchart showing an example of the process executed by the television receiver 110a and the smartphone 110b.

First, the receiver 21a receives the content stream 3 (step 1: hereinafter abbreviated as S1), and the sound processor 61 and the image processor 63 output content (sound information 4a, video information 4b) to the sound output unit 52 and the display unit 51a (S2, first output step).

The speech recognition unit 62 recognizes the sound information 4a and converts it into text information 5 (S3), and a keyword detector 15 detects the keyword from the text information (S4, extraction step). The keyword display processor 18 displays the detected keyword 1 on the display unit 51b (S5).

The keyword selector 16 determines whether or not the keyword 1 was selected by the user (S6). Once selected (YES in S6), the keyword is converted to a search command 7b by the search term acquisition unit 71, and the transmitter 22 sends the search command (S7) to a prescribed search engine and the like. The receiver 21b receives the search result 7a and the result display controller 72 converts the search result to related information 2 (S8).

Once the keyword-related information acquisition unit 17 acquires the related information 2 and outputs it to the keyword display processor 18 (S9, acquisition step), the keyword display processor 18 outputs the related information to the display unit 51b (S10, second output step).

### Effects of Display System 100

The display system 100 can output a keyword 1 detected from the content (sound information 4a) to the display unit 51b of a smartphone 110b which is not the display unit 51a of the television receiver that outputs content. As a result, the display system 100 can suggest keywords to the user without inhibiting the output of the content.

Also, the smartphone 110b can focus on the process of acquiring related information 2 associated with the keyword 1 since it does not need to execute the process of detecting the keyword 1 because the television receiver 110a detects the keyword 1 from the content. In other words, the calculation load is distributed. Thus, in effect, the smartphone 110b of the display system 100 can smoothly acquire related information 2 even if the computational resource of the smartphone 110b is insufficient.

In addition, the smartphone 110b displays sequentially detected keywords 1 in parallel with the progress of the content outputted by the television receiver 110a. Thus, the user can acquire related information 2 associated with the keyword by simply selecting a keyword 1 displayed on the smartphone 110b. Therefore, the display system 100 can instantaneously acquire related information 2 in parallel with the progress of the content outputted by the television receiver 110a, without the user having to input a keyword 1.

### Other Configuration of Display System 100

As shown in FIG. 3(a), since the display system 100 can be attained as one device, the display system can also be configured as follows. That is, the output device may be an output device that outputs content provided with a first output part that outputs the content, an extraction part that extracts a character string from the content outputted by the first output part, an acquisition part that acquires related information of a character string selected by a user out of the character string extracted by the extraction part, and a second output part that outputs the related information acquired by the character string and the acquisition part.

### Embodiment 2

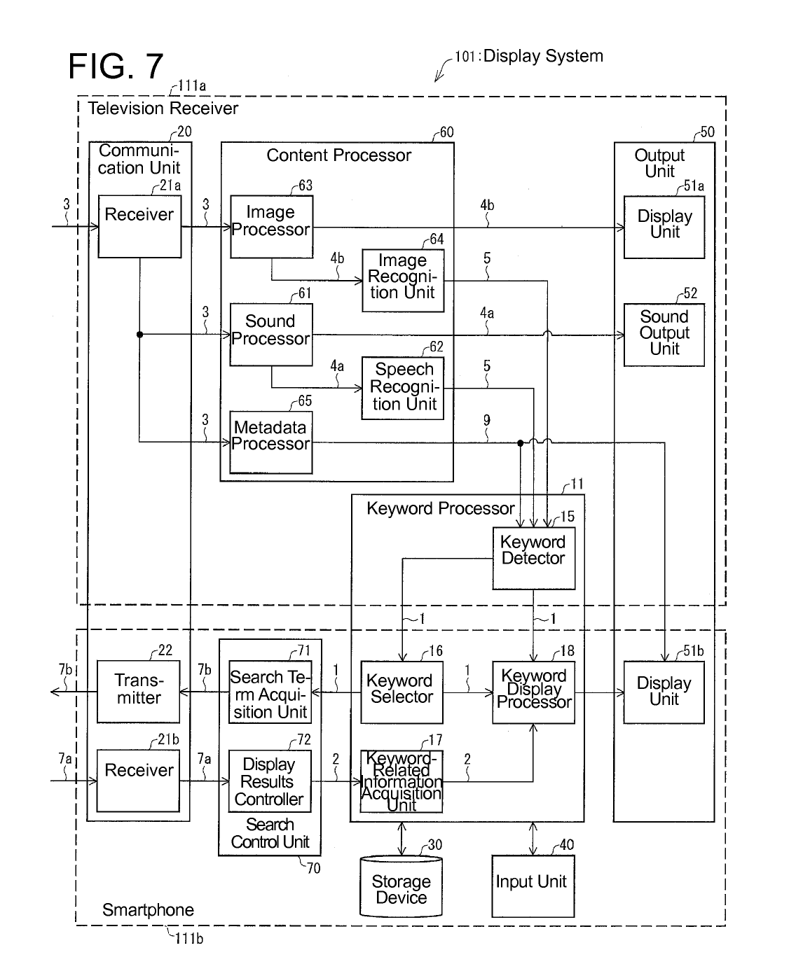

Below, Embodiment 2 of the present invention will be described in detail with reference to FIGS. 7 to 9. Also, the explanation of the present embodiment will mainly be about only the functions and configurations added to the Embodiment 1. In other words, the configurations and the like of Embodiment 1 will also be included in Embodiment 2. Also, the definitions of the terms described for Embodiment 1 are the same for Embodiment 2

### Configuration of Display System 101

The configuration of a display system 101 related to the present embodiment will be described with reference to FIG. 7. FIG. 7 is a block diagram showing the configuration of the main parts of the display system 101. The display system (output system) 101 is different from the display system 100 (refer to FIG. 1) in that the display system 101 includes a television receiver (first output device) 111a and a smartphone (second output device) 111b, and that the television receiver 111a includes an image recognition unit 64 and a metadata processor 65 in addition to the components in the television receiver 110a.

Also, parts and components that are not directly related to the present embodiment are omitted from the explanation of the configuration and the block diagram as described above. Furthermore, only the functions of the image recognition unit 64 and the metadata processor 65 and the functions added to the keyword detector 15 and the keyword display processor 18 will be described, and configurations that are the same as the configurations in the aforementioned display system 100 are assigned the same reference characters and descriptions thereof will be omitted.

The image recognition unit (extraction part) 64 sequentially recognizes video information 4b inputted in real-time from an image processing unit 63. More specifically, the image recognition unit 64 recognizes the character strings in each frame that composes the video information 4b (such as subtitles embedded in the image, characters in a signboard showing in the background, and the like), and by doing so, the video information 4b is converted into text information 5 and the converted text information 5 is outputted to the keyword detector 15. For the above-mentioned recognition and conversion, well-known video recognition (image recognition) technology can be used.

If the video information 4b is recognized using a well-known video recognition (image recognition) technology, the specificity of the keyword 1 may decrease. To address this problem, the keyword detector 15 determines whether or not the sound information 4a and the video information 4b detected the same keyword at the same time based on the time stamp attached to the keyword 1. Also, the keyword detector 15 only outputs a keyword 1 that is detected repeatedly in both sound information 4a and video information 4b and comes up repeatedly in a prescribed time period (10 seconds, for example), to the keyword selector 16.

In other words, the keyword detector 15 may select a keyword to output according to a priority level given according to whether or not the keyword was detected repeatedly in both sound information 4a and video information 4b, how many times it was detected in both, and the like. As a result, the above-mentioned problem of the decreased specificity of the keyword 1 can be solved.

The metadata processor 65 acquires metadata 9 that corresponds to the broadcasting station specified by the user from the content stream 3 inputted from the receiver 21a and outputs the metadata to the keyword detector 15 and the display unit 51b.

The keyword detector 15 detects the keyword 1 from the text information inputted from the speech recognition unit 62 and the image recognition unit 64, and the metadata 9 inputted from the metadata processor 65. Here, the keyword 1 detected through the speech recognition unit 62 recognizing the sound information 4a, the keyword 1 detected through the image recognition unit 62 recognizing the video information 4b, and the keyword 1 detected based on the metadata 9 can each be outputted by the keyword display processor 18 with different colors, fonts, sizes, and the like to the display unit 51b to let the user identify each keyword visually.

If the keyword detector 15 stores the keyword 1 in a storage device 30, the information showing the type of information (sound information 4a or video information 4b) recognized in addition to the time stamp can be stored in correspondence with the keyword. As a result, keywords 1 can be referred to based on the type of information it was retrieved from, which improves the accessibility of the keywords 1.

### Example of Display Showing Keyword 1 with Smartphone 111b

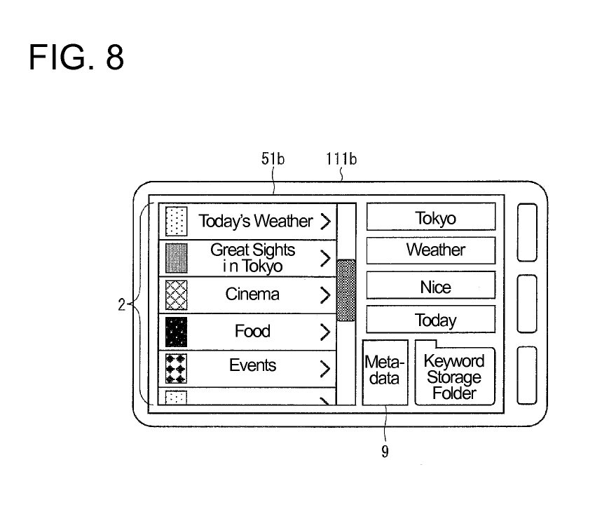

Based on FIG. 8, an example of a display showing a keyword 1 in a smartphone 111b will be described. FIG. 8 is a schematic view of a sample display showing metadata 9 in addition to the keyword 1 in the smartphone 111b.

As mentioned above, the metadata processor 65 outputs the metadata 9 to the display unit 51b. As a result, the metadata 9 can be directly displayed on the display unit 51b. The metadata processor 65 does not have to output the metadata 9 to the display 51b constantly. As shown in FIG. 8, the metadata processor 65 may display the metadata 9 on the display unit 51b only when the user presses the prescribed button (“metadata button,” for example). When the metadata 9 is displayed, the metadata processor 65 may display the metadata along with the keyword 1.

The keyword detector 15 may store the metadata 9 inputted from the metadata processor 65 and the keyword 1 detected from the metadata, in the storage device 30 (or other storage devices not shown in FIG. 7). The process here is the same as the process executed for the keyword 1 detected based on the sound information 4a and the video information 4b, in which the files are stored according to the time stamp and the type of information, and metadata 9 is deleted once the prescribed period has passed.

If the keyword detector 15 stores the metadata 9 in the storage device 30, the metadata processor 65 can read the metadata 9 stored in the storage device 30 and display the read metadata 9 to the display unit 51b.

### Process Executed by Television Receiver 111a and Smartphone 111b

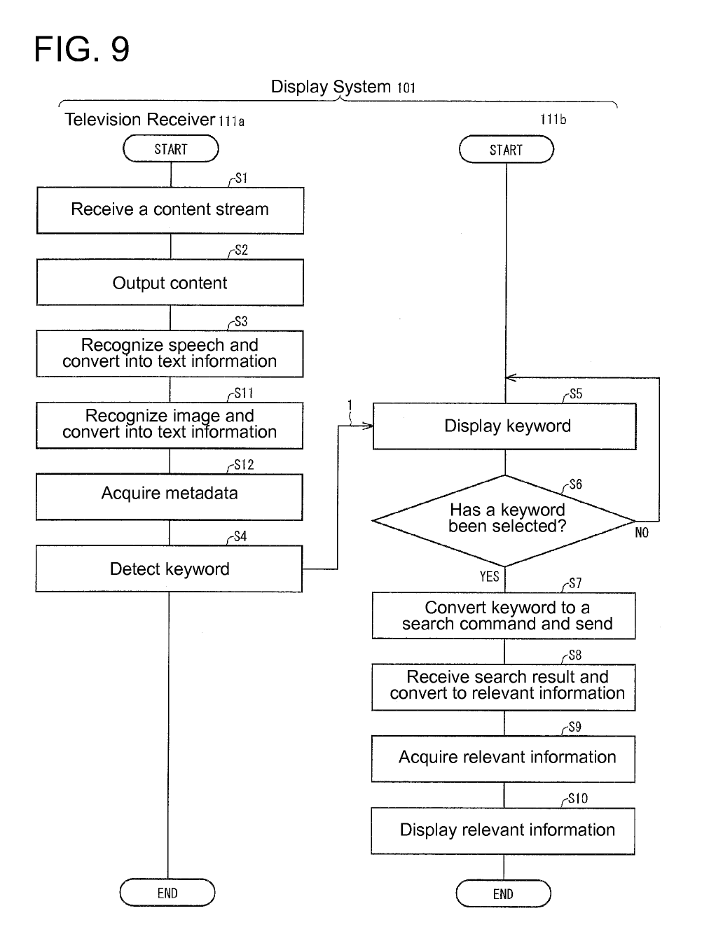

Based on FIG. 9, the flow of the process executed by the television receiver 111a and the smartphone 111b will be explained. FIG. 9 is a flowchart showing an example of the process executed by the television receiver 111a and the smartphone 111b.

Here, the steps executed by the television receiver 111a and the smartphone 111b are mostly the same as the steps executed by the television receiver 110a and the smartphone 110b described with FIG. 6; the same steps are assigned the same reference characters and are not described again. Thus, only the process executed by the image recognition unit 64 and the metadata processor 65 (S11 and S12 in FIG. 9) will be explained.

After the speech recognition unit 62 recognizes the sound information 4a and converts it into text information 5 (S3), the image recognition unit 64 recognizes the video information 4b and converts it into text information 5 (S11). Also, the metadata processor 65 acquires metadata 9 that corresponds to the user specified broadcasting station from the content stream 3 (S12).

### Effects of Display System 101

The display system 101 can acquire a broader variety of keywords 1 than in a case in which keywords 1 are only detected from sound information through a keyword detector 15.

Also, the display system 101 can use the information of whether or not the sound information 4a and the video information 4b both detected the same keyword as a standard for keyword detection, and thus can detect keywords 1 that better match the details of the content.

The display system 101 can give the highest priority to a keyword that is repeatedly detected in both sound information 4a and video information 4b, give the next highest priority to information repeatedly detected in either the sound information 4a or the video information 4b, and give the lowest priority to a keyword that is not detected repeatedly in either the sound information 4a or the video information 4b, for example.

### Embodiment 3

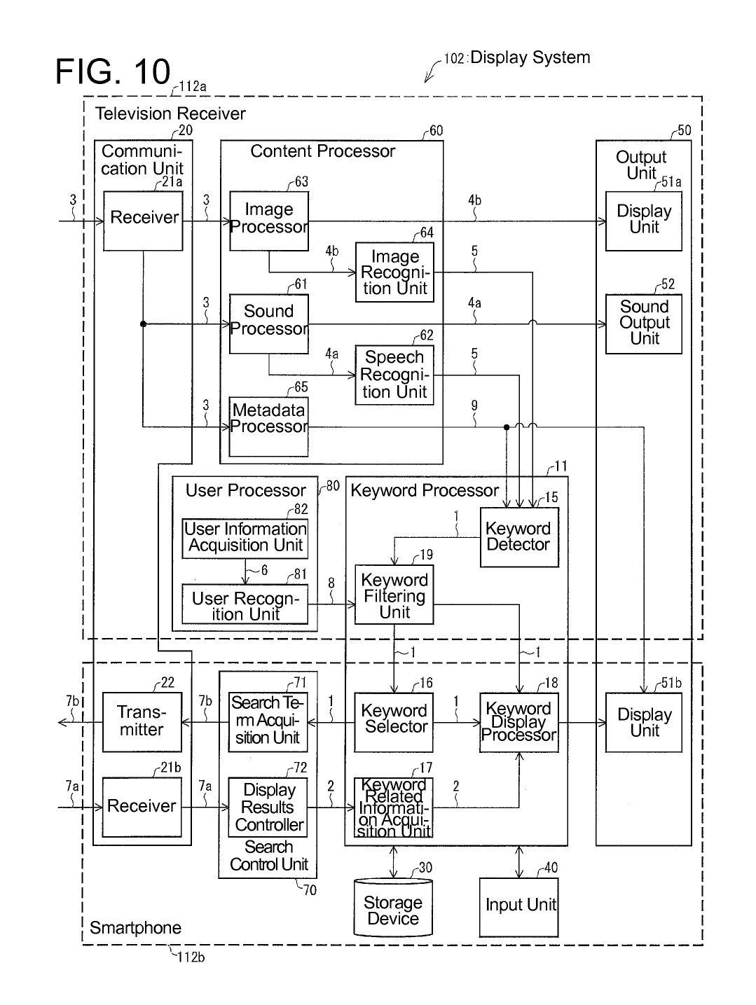

Below, Embodiment 3 of the present invention will be described in detail with reference to FIGS. 10 to 12. Also, the explanation of the present embodiment will mainly be about only the functions and configurations added to Embodiments 1 and 2. In other words, the configurations and the like of Embodiments 1 and 2 will also be included in Embodiment 2. Also, the definitions of the terms described for Embodiments 1 and 2 are the same for Embodiment 3.

### Configuration of Display System 102

The configuration of a display system 102 related to the present embodiment will be described with reference to FIG. 10. FIG. 10 is a block diagram showing the configuration of the main parts of the display system 102. The display system (output system) 102 is different from the display system 100 (refer to FIG. 1) and the display system 101 (refer to FIG. 7) in that the display system 102 includes a television receiver (first output device) 112a and a smartphone (second output device) 112b, and in that the television receiver 112a includes a user processor 80 (user recognition unit 81, user information acquisition unit 82) and a keyword filtering unit 19 in addition to the components in the television receiver 110a and 111a.

Also, parts and components that are not directly related to the present embodiment are omitted from the explanation of the configuration and the block diagram as described above. Furthermore, only the functions of the user processor 80 (user recognition unit 81, user information acquisition unit 82) and the keyword filtering unit 19 will be explained below, and configurations that are the same as the configurations in the aforementioned display systems 100 and 101 are assigned the same reference characters and descriptions thereof will be omitted.

The user processor 80 identifies the user using the display system 102. The user processor 80 includes a user recognition unit 81 and a user information acquisition unit 82.

The user information acquisition unit 82 acquires information about the user using the display system 102 and outputs the information to the user recognition unit 81.

The user recognition unit (detection part, determination part) 81 recognizes the user based on the inputted user information. Specifically, first the user recognition unit 81 detects the identification information 6 to identify the user. Identification information 6 that is associated with interest information 8 is stored in the storage device 30 (or other storage devices not shown in FIG. 10), and the user recognition unit 81 determines whether or not the stored identification information 6 and the extracted identification information 6 match. If the stored identification information 6 and the extracted identification information 6 match, then the user recognition unit 81 outputs the interest information 8 of the user that matched the identification information to the keyword filtering unit 19.

Here, the interest information 8 is information that indicates the user's interests. The interest information 8 includes terms related to the things the user is interested in (genre, name of a television show, and the like). The user sets the interest information 8 in the television receiver 112a in advance.

The information on the user acquired by the user information acquisition unit 82 depends on the recognition process executed by the user recognition unit 81. The television receiver 112a may be provided with a camera that can acquire a facial image of the user, and the user recognition unit 81 may recognize the user by recognizing the facial image. In this case, the user recognition unit 81 may detect the facial characteristics (shape, position, size, color, and the like of each parts of a face) included in the facial image to use for detection and recognition.

Otherwise, the television receiver 112a may be provided with a device as a user information acquisition unit 82 that can read the fingerprint of the user, and the user recognition unit 81 may recognize the user by recognizing the fingerprint. In this case, the user recognition unit 81 can detect the characteristics of the finger and the fingerprint (such as size and shape of the finger) included in the facial image as the identification information 6 and uses it for recognition.

Otherwise, the user may be recognized by verifying the username and the password inputted by the user through the input unit 40 (or other input units not shown in FIG. 10), or the user may be recognized by the television receiver 112a receiving a unique identifier such as a product serial number sent from the smartphone 112b. In such a case, the user recognition unit 81 detects the user name, password, and product serial number as the identification information 6.

In other words, the user processor 80 (user recognition unit 81, user information acquisition unit 82) and the keyword filtering unit 19 may be included in the television receiver 112a or the smartphone 112b.

The keyword filtering unit (selection part) 19 filters the keyword 1 inputted from the keyword detection part based on the interest information 8 inputted from the user recognition unit 81 and outputs the filtered keyword 1 to the keyword selector 16 and the keyword display processor 18. The method of filtering will be explained later in detail.

Also, the smartphone 112b may be provided with the user processor 80 (user recognition unit 81, user information acquisition unit 82) and the keyword filtering unit 19 and execute the user recognition and the filtering of the keyword 1 mentioned above.

### Filtering Process of Keyword 1

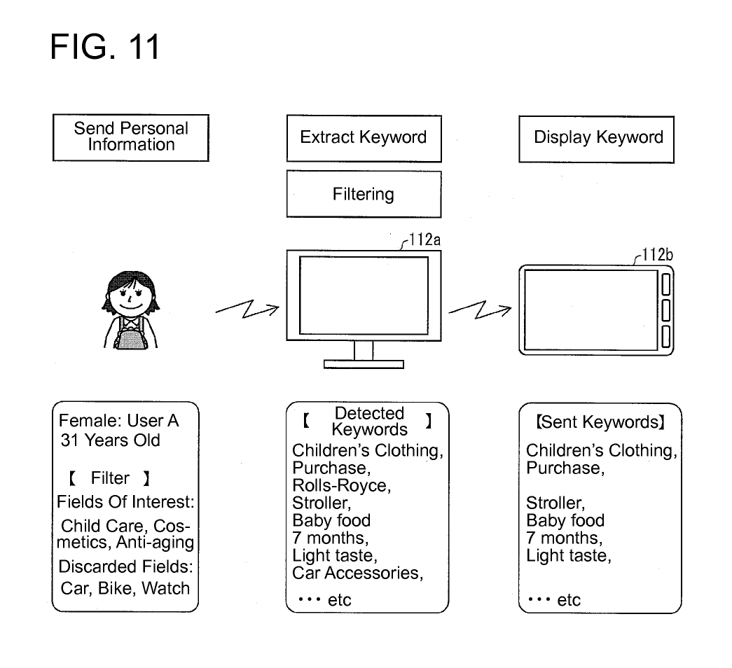

The process executed by the keyword filtering unit 19 will be described based on FIG. 11. FIG. 11 is a schematic view of the steps of the process executed by the keyword filtering unit 19.

As shown in FIG. 11, the “fields of interest” in the interest information of the user (“User A” in FIG. 11) are set as “child care”, “cosmetics,” and “anti-aging.” Furthermore, the “discarded fields” are set as “car,” “bike,” and “watch.” When the above-mentioned interest information 8 is inputted from the user recognition unit 81, the keyword filtering unit 19 filters the keyword 1 detected by the keyword detector 15.

As shown in FIG. 11, if the keyword 1 includes “children's clothing,” “purchase,” “Rolls-Royce,” and “stroller,” since “car” is included in the “discarded fields” of the interest information 8, the keyword filtering unit 19 discards “Rolls-Royce” and “car accessories.”

The keyword filtering unit 19 outputs the filtered keyword 1 to the keyword selector 16 and the keyword display processor 18, and thus the smartphone 112b displays keywords 1 other than “Rolls-Royce” and “car accessories” in the display unit 51b.

Above, an example of filtering keywords 1 using “fields of interest” and “discarded fields” is given, but the keyword filtering unit 19 may use other filters. If the interest information 8 includes the age, gender, country of birth, and the like of the user, the keyword filtering unit 19 may execute filtering using such information.

Furthermore, the keyword filtering unit 19 may store a keyword 1 that the user selected in the past to search in a search history in a storage device 30 (or another storage device not shown in FIG. 10), predict the keyword 1 that the user may be interested in based on the history, and filter using the predicted keyword 1.

### Process Executed by Television Receiver 111a and Smartphone 111b

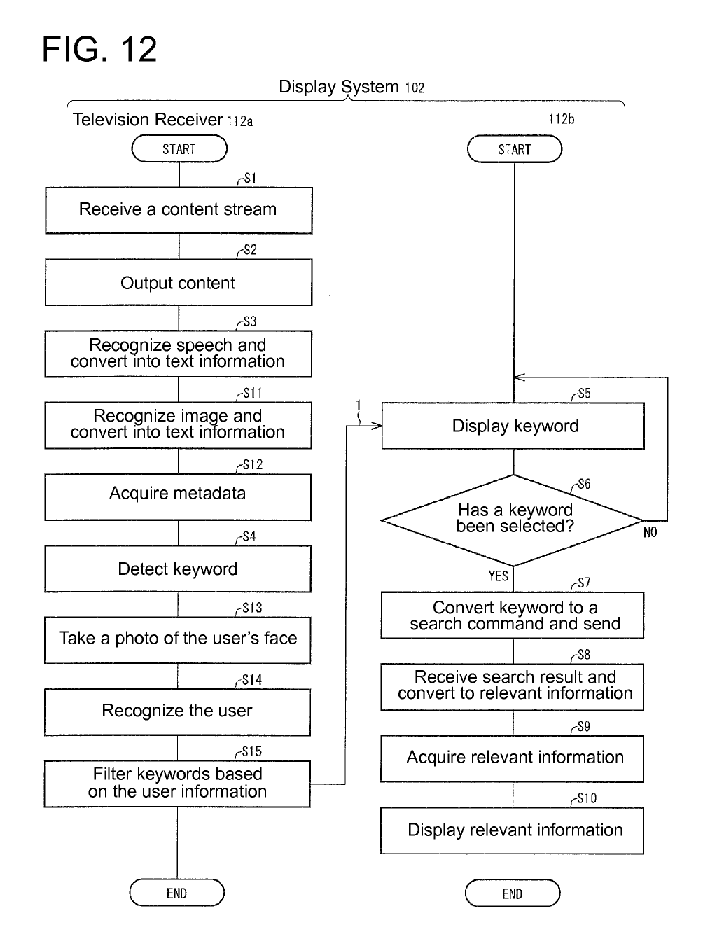

Based on FIG. 12, the flow of the process executed by the television receiver 112a and the smartphone 112b will be explained. FIG. 12 is a flowchart showing an example of the process executed by the television receiver 112a and the smartphone 112b.

Here, many of the steps executed by the television receiver 112a and the smartphone 112b are mostly the same as the steps executed by the television receiver 110a and the smartphone 110b and the steps executed by the television receiver 111a and the smartphone 111b, described with reference to FIGS. 6 and 9 respectively; the same steps are given the same reference characters and are not described again. Thus, only the steps (S13 to S15 of FIG. 12) executed by the user recognition unit 81, user information acquisition unit 81, and keyword filtering unit 19 will be described below.

After the keyword detector 15 detects keyword 1 from text information 5 (S4), the user information acquisition unit 82 takes a photograph of the face of the user (S13). The user recognition unit 81 recognizes the user through the process described above (S14). Also, while an example was described of the process in which the television receiver 112a includes as the user information acquisition unit 82 a camera that can take a photograph of a user, and the user recognition unit 81 recognizes the user by recognizing the photograph of the user, other methods or configurations to recognize the user can be used.

The keyword filtering unit 19 filters the keyword 1 detected by the keyword detector 15 based on the interest information 9 of the recognized user. The keyword filtering unit 19 outputs the filtered keyword 1 to the keyword selector 16 and keyword display processor 18 of the smartphone 112b.

### Effects of Display System 102

The display system 102 can reduce the load of sending keywords 1 by only sending the keywords 1 that are thought to be favorable to the user from the television receiver 112a to the smartphone 112b, among the keywords 1 detected from the content.

Also, the display system 102 can improve convenience for the user by only displaying the keywords 1 on the smartphone 112b that interest the user.

### Embodiment 4

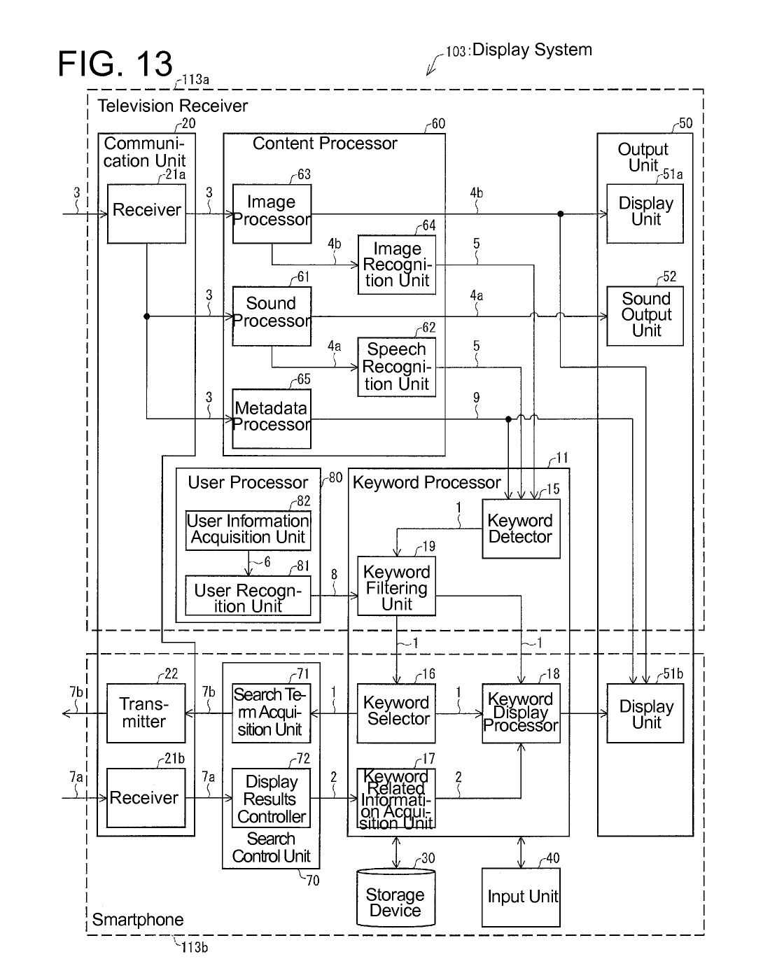

Below, Embodiment 4 of the present invention will be described in detail with reference to FIGS. 13 to 15. Also, the explanation of the present embodiment will mainly be about only the functions and configurations added to Embodiments 1 to 3. In other words, the configurations and the like of Embodiments 1 to 3 will also be included in Embodiment 4. Also, the definitions of the terms described for Embodiments 1 to 3 are the same for Embodiment 4.

### Configuration of Display System 103

The configuration of a display system 103 related to the present embodiment will be described with reference to FIG. 13. FIG. 13 is a block diagram showing the configuration of the main parts of the display system 103. The display system 103 is different from the display system 100 (refer to FIG. 1), display system 101 (refer to FIG. 7), and display system 102 (refer to FIG. 10), in that the display system 103 includes a television receiver (first output device) 113a and smartphone (second output device) 113b, and in that the image processor 63 of the television receiver 113a outputs the image information 4b to the display unit 51b of the smartphone 113b.

Also, parts and components that are not directly related to the present embodiment are omitted from the explanation of the configuration and the block diagram as described above. Furthermore, only the functions added to the image processor 63 will be explained below, and configurations that are the same as the configurations in the aforementioned display systems 100 to 102 are assigned the same reference characters and descriptions thereof will be omitted.

The image processing part 63 separates the image information (content) that corresponds to the user-selected broadcasting station of the content stream 3 inputted from the receiving part 21a, and outputs the information to the display parts 51a and 51b. Other functions are the same as those mentioned in Embodiments 1 to 3.

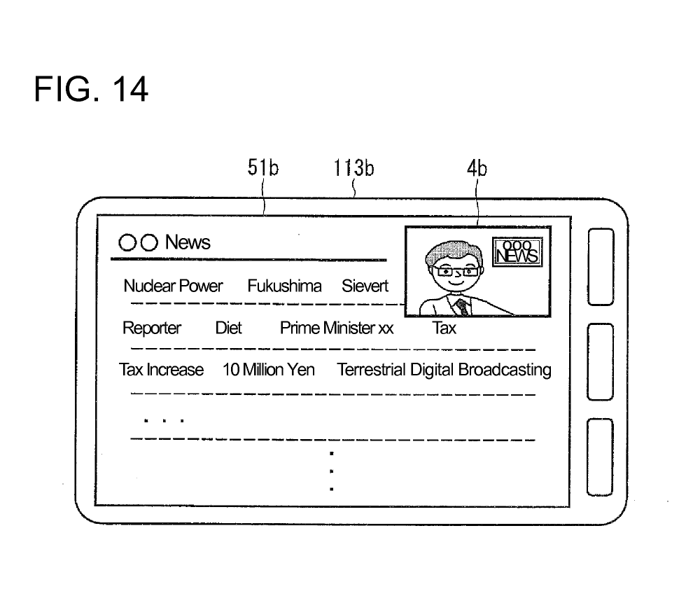

An example of a display of the smartphone 113b will be described based on FIG. 14. FIG. 14 is a schematic view of an example of a display showing keywords 1 on the smartphone 113b. As shown in FIG. 14, the television receiver 113a sends the image information 4b along with the keywords 1 to the smartphone 113b, and the smartphone 113b outputs the image information 4b sent by the television receiver 113a.

As a result, the user can see both the content outputted by the television receiver 113a and the keywords 1 outputted by the smartphone 113b simultaneously without the user needing to switch back and forth between looking at the television receiver 113a and the smartphone 113b.

Also, the image processor 63 may output the image information 4b to the display unit 51b at a lower resolution. As a result, the load of sending the information from the television receiver 113a to the smartphone 113b can be reduced.

### Process Executed by Television Receiver 113a and Smartphone 113b

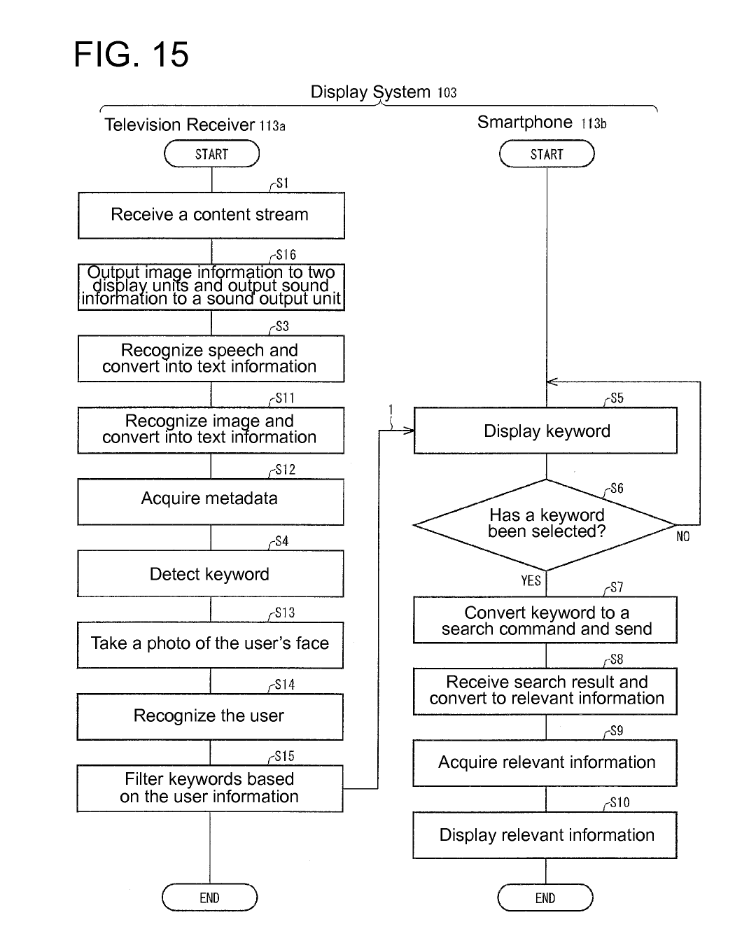

Based on FIG. 15, the flow of the process executed by the television receiver 113a and the smartphone 113b will be explained. FIG. 15 is a flowchart showing an example of the process executed by the television receiver 113a and the smartphone 113b.

Here, the steps executed by the television receiver 113a and the smartphone 113b are mostly the same as the steps executed by the television receiver 110a and the smartphone 110b, the steps executed by the television receiver 111a and the smartphone 111b, and the steps executed by the television receiver 112a and smartphone 112b, described with reference to FIGS. 6, 9, and 12, respectively; the same steps are assigned the same reference characters and are not described again. Thus, only the process S16 executed instead of S2 executed in FIGS. 6, 9, and 12 will be described.

When the receiver 21a receives the content stream 3 (S1), the sound processor 61 outputs the sound information 4a to the sound output unit 52, and the image processor 63 outputs the image information 4b to the display units 51a and 51b.

### Effects of Display System 103

The display system 103 allows the user to see both the content outputted by the television receiver 113a and the keywords 1 outputted by the smartphone 113b simultaneously without the user needing to switch back and forth between looking at the television receiver 113a and the smartphone 113b.

Also, as mentioned above, the real time effect of the content and the keywords 1 is preserved as the user sees both simultaneously.

### Combinations of Configurations (Technical Parts) Included in Embodiments

It should be noted that the configurations of the Embodiments 1 to 4 can be combined as appropriate. In other words, none of the configurations explained in Embodiments 1 to 4 are limited to the embodiments explained, and the configurations can also be used in other embodiments in part or in whole, and embodiments formed in this manner are also included in the technical scope of the present invention.

Furthermore, the present invention is not limited to the above-mentioned embodiments, and various modifications can be made without departing from the scope of the claims. That is, embodiments obtained by combining techniques modified without departing from the scope of the claims are also included in the technical scope of the present invention.

For example, the display system 103 related to Embodiment 4 was described as including all configurations in display systems 100 to 102 related to Embodiments 1 to 3, but this may not always be the case. For example, the display system 103 does not need to include an image recognition unit 64 or a keyword filtering unit 19. On the other hand, the display system 100 according to Embodiment 1 does not include an image recognition unit 64, for example, but it may include one to match other embodiments.

### Example of Using Software

Finally, each block for display systems 110 to 103 (television receiver 110a to 113a, smartphone 110b to 113b) may be realized as hardware by using a logic circuit formed on an integrated circuit chip (IC chip), or the display system may use a CPU for a software-based solution.

In the case of the latter, the display systems 100 to 103 are each provided with a CPU that executes commands of a program that realizes each function, a ROM (read only memory) that stores the program, and a storage device such as a memory that stores the program and various data. Therefore, an object of the present invention can be achieved by having a computer (or CPU, MPU) read and execute the program code recorded in a storage media that allows the program code (executable program, intermediate code program, source program) of the control program of the display systems 100 to 103 to be read by a computer, in which the program code is a software that realizes the above-mentioned functions.

The storage media can be tapes such as a magnetic tape or a cassette tape; magnetic disks such as a floppy (registered trademark) disk or a hard disk; discs including optical discs such as CD-ROMs, MOs, MDs, DVDs, and CD-Rs; cards such as an IC card (includes memory cards) or an optical card; semiconductor memories such as a mask ROM, an EPROM, an EEPROM, or a flash ROM; or logic circuits such as a PLD (programmable logic device) or FPGA (field programmable gate array).

Also, the above-mentioned program code can be supplied through a communication network by configuring the display system 100 to 103 so as to make them connectible to a communication network. As long as the communication network can send the program code, there are no limits to what can be used. The internet, intranet, extranet, LAN, ISDN, VAN, CATV network, virtual private network, telephone network, cellular line, satellite communication network, and the like can be used, for example. Also, as long as the transmission medium that configures the communication network can send the program code, transmission medium is not limited to a particular configuration or type. Wired connections such as IEEE1394, USB, power-line carrier, cable television line, telephone wire, ADSL (asymmetrical digital subscriber line); infrared connections such as IrDA or remote controllers; or wireless connections such as Bluetooth (registered trademark), IEEE802.11 wireless, HDR (high data rate), NFC (near field communication), DLNA (Digital Living Network Alliance), mobile phone network, satellite circuit, or terrestrial digital network can be used. Also, the present invention can be realized as a computer data signal embedded in a carrier wave in which the above-mentioned program code has been realized through electronic transmission.

As described, the parts in the present specification are not limited to physical parts, but also include cases in which the functions of the parts are realized by software. Also, the function of one part can be realized by two or more physical parts, and functions of two or more parts can be realized by one physical part.

### SUMMARY

The output system (display system 100, display system 101, display system 102, and display system 103) related to Embodiment 1 of the present invention

(1) is an output system that outputs content, including

(2) a first output device (television receiver 110a, television receiver 111a, television receiver 112a, and television receiver 113a) and a second output device (smartphone 110b, smartphone 111b, smartphone 112b, smartphone 113b),

(3) the first output device including:

(3a) a first output part (display unit 51a, sound output unit 52) that outputs the content,

(3b) an extraction part (keyword detector 15, speech recognition unit 62, image recognition unit 64) that extracts character strings from the content outputted by the first output part,

(4) the second output device including:

(4a) an acquisition part (keyword selector 16, keyword-related information acquisition unit 17) that acquires information (related information 2) from outside related to a character string selected by a user from the character strings extracted by the extraction part; and

(4b) a second output part (display unit 51b) that outputs the character strings and the information related to the character string acquired by the acquisition part.

Next, the control method of the output system related to Embodiment 1 of the present invention includes:

(1) a first output device and a second output device that output content;

(2) a first output step (S2) that outputs the content;

(3) an extraction step (S4) in which a character string is extracted from information included in the content outputted by the first output step;

(4) an acquisition step (S9) in which information related to a character string selected by a user from the character string extracted by the extraction step is acquired from outside; and

(5) a second output step (S10) in which the character string and the information acquired by the acquisition step and related to the character string is outputted.

According to the configuration above, the output system related to Embodiment 1 of the present invention includes a first output device and a second output device. The first output device outputs content and sends character strings extracted from the content to the second output device. The second output device acquires information related to the character string selected by the user from the character strings sent by the first output device, and outputs the information along with the selected character string.

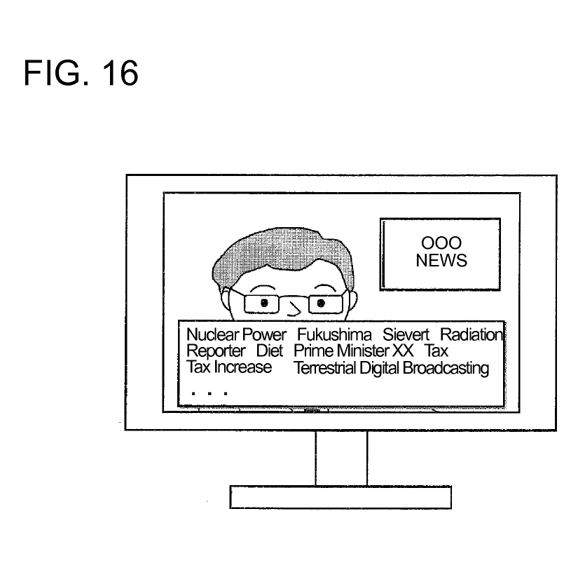

As mentioned before in reference with FIG. 16, conventional display devices display character strings (keywords) on top of the content in the same display screen, reduces the size of the content, and the like, and inhibits the display of the content. As a result, there is a problem that users cannot comfortably watch the content. Also, a conventional display device executes the process of extracting character strings from the content as well as the process of acquiring information related to a character string, and thus faces the problem of the calculation load being applied only to the display device.

As a countermeasure, the control method of the output system and the control method of the output system related to Embodiment 1 of the present invention can suggest character strings to the user without interfering with the output of the content by the first output device.

Also, the second output device can concentrate on acquiring information related to a character string since the first output device detects keywords from content, and thus, the second output device does not need to detect character strings. In other words, the calculation load is distributed. Therefore, the second output device can smoothly acquire related information even if the computational resource of the second output device is insufficient.

Additionally, the user can obtain information related to keywords by simply selecting the keywords outputted by the second output device. As a result, the user can immediately acquire related information without entering a character string.

Also, in the above-mentioned Embodiment 1 in regards to the second output device related to Embodiment 2 of the present invention,

(1) the second output part may output the extracted character strings extracted by the extraction part in real time.

According to the above-mentioned configuration, the second output device of the output system related to Embodiment 2 outputs the character strings extracted by the first output device in real-time. Therefore, the user can acquire related information in real time as the user can select a character string at the same time as the first output device outputs content.

Also, in Embodiments 1 and 2, at least one of the first output device and second output device of the output system related to Embodiment 3 includes:

(1) a detection part (user recognition unit 81) that detects the identification information that identifies the user;

(2) a determination part (user recognition unit 81) that determines whether or not the identification information detected by the detection part matches identification data that has been associated with interest information that indicates interests of the user; and

(3) a selection part (keyword filtering unit 19) that selects the character string outputted by the second output part based on the interest information associated with the matched identification data, if the determination part determines that the identification data matches the identification data.

According to the configuration mentioned above, at least one of the first and second output devices of Embodiment 3 of the present invention detects the identification information that identifies the user and determines whether or not the identification information detected by the detection part matches the identification information that has been associated with information on interests of a user. Then, if it is determined that there is a match, the first output device will sort (filter) the character strings based on the interest information of the user corresponding to the identification information that matched.

Therefore, the output system related to Embodiment 3 of the present invention can send only the character strings that are considered preferable for the user to the second output device from the first output device.

As a result, the output system related to Embodiment 3 of the present invention can reduce the transmission load. Also, the output system related to Embodiment 3 of the present invention can improve convenience for the user by only showing the character strings on the second output device that interest the user.

Also, in the first output device related to Embodiment 4 of the present invention in the above-mentioned response 3,

(1) the detection part may detect the facial image of the user as an identification information.

In other words, a facial image of the user is an example of identification information for the first output device of an output system related to Embodiment 4 of the present invention. In this case, the first output device can detect the facial characteristics (shape, position, size, color, and the like of each parts of a face) included in the facial image to use for detection and recognition.

Also, for the first output device related to Embodiment 5 of the present invention according to any one of the above-mentioned Embodiments 1 to 4,

(1) the content includes sound, and

(2) the extraction part extracts the character strings from the sound by recognizing said sound.

In other words, when the first output device of the output system related to the present invention extracts a character string from the content, the extraction can be performed through recognizing the sound included in the content.

Also, for the first output device related to Embodiment 6 of the present invention according to any one of the above-mentioned Embodiments 1 to 5,

(1) the content includes video, and

(2) the extraction part extracts the character strings from the video by recognizing an image included in the video.

In other words, when the first output device of the output system related to Embodiment 6 of the present invention extracts a character string from the content, the extraction can be done through recognizing the video included in the content. Therefore, the output system related to Embodiment 6 of the present invention can obtain a greater variety of character strings and thus further improve convenience for the user.

In addition, in the first output device related to Embodiment 7 of the present invention according to any one of the above-mentioned Embodiments 1 to 6,

(1) the content includes metadata, and

(2) the extraction part may extract the character strings from the metadata.

In other words, if the first output device of the output system related to Embodiment 7 of the present invention extracts character strings, the character strings can be detected particularly from the metadata included in the content. Therefore, the output system related to Embodiment 7 of the present invention can obtain a greater variety of character strings and thus further improve convenience for the user.

Also, in the output system related to Embodiment 8 of the present invention is any one of the above-mentioned Embodiments 1 to 7,

(1) the second output part may further output content outputted by the first output part.

Therefore, according to the output system related to Embodiment 8 of the present invention, the user can see both the content outputted by the first output device and the character strings outputted by the second output device at once simultaneously without the user needing to switch back and forth between looking at the first output part and the second output part. As a result, the user can watch the content without losing the real-time nature of the content and the character strings.

Also, the output system (first output device, second output device) may be realized by a computer. In this case, by operating the computer as each part of the output system, the control program that realizes the output system with a computer and a storage media that can be read by a computer storing the control program is also included in the scope of the present invention.

### INDUSTRIAL APPLICABILITY

The present invention is applicable to a system that includes at least two output devices. It is especially suitable for a television system including a television receiver and a smartphone. Also, personal computers, tablets, and other electronic devices that can output content can be used instead of a television receiver or a smartphone.

### DESCRIPTION OF REFERENCE CHARACTERS

1 keyword (character string)

2 related information (related information)

4a sound information (content, sound)

4b video information (content, video)

6 identification information

8 interest information

9 metadata

15 keyword detector (extraction part)

16 keyword selector (acquisition part)

17 keyword-related information acquisition unit (acquisition part)

18 keyword display processor (second output part)

19 keyword filtering unit (selection part)

51a display unit (first output part)

51b display unit (second output part)

52 sound output unit (first output part)

62 speech recognition unit (extraction part)

64 image recognition unit (extraction part)

81 user recognition unit (detection part, determination part)

100 display system (output system)

101 display system (output system)

102 display system (output system)

103 display system (output system)

110a television receiver (first output device)

110b smartphone (second output device)

111a television receiver (first output device)

111b smartphone (second output device)

112a television receiver (first output device)

112b smartphone (second output device)

113a television receiver (first output device)

113b smartphone (second output device)

1. An output system that outputs audio, visual, or audiovisual content, comprising a first output device and a second output device,
wherein the first output device includes:
a first output part that outputs said content to a user; and
an extraction part that extracts character strings from said content outputted by the first output part,
wherein the second output device includes:
an acquisition part that acquires information from an outside source related to a character string selected by the user from the character strings extracted by the extraction part; and
a second output part that outputs the extracted character strings, the information related to the user-selected character string acquired by the acquisition part, or both to the user.

2. The output system according to claim 1,
wherein the extraction part extracts the character strings from said content outputted by the first output part in real time, and
wherein the second output part outputs the character strings extracted by the extraction part to the user in real time.

3. The output system according to claim 1,
wherein at least one of the first output device and the second output device includes:
a detection part that detects inputted identification data that identifies the user;
a determination part that determines whether or not the inputted identification data detected by the detection part matches stored identification data that has been associated with interest information that indicates interests of the user; and
a selection part that selects the character string outputted by the second output part based on the interest information associated with the stored identification data that matches the inputted identification data, if the determination part determines that the inputted identification data matches the stored identification data.

4. The output system according to claim 3, wherein the detection part detects a facial image of the user as the inputted identification data.

5. The output device according to claim 1,
wherein said content includes sound, and
wherein the extraction part extracts the character strings from the sound by recognizing said sound.

6. The output device according to claim 1,
wherein said content includes video, and
wherein the extraction part extracts the character strings from the video by recognizing an image included in the video.

7. The output device according to claim 1,
wherein said content includes metadata, and
wherein the extraction part extracts the character strings from the metadata.

8. The output device according to claim 1, wherein the second output part also outputs the content outputted by the first output part.

9. A control method of an output system that includes a first output device and a second output device that output audio, visual, and audiovisual content, the method comprising;
a first output step of outputting said content to a user;
an extraction step of extracting character strings from information included in the content outputted by the first output step;
an acquisition step of acquiring information from an outside source that is related to a character string selected by the user from the character strings extracted by the extraction step; and
a second output step of outputting to the user the extracted character strings, the information acquired by the acquisition step and related to the selected character string, or both is outputted.

10. A non-transitory storage medium that stores a control program for operating at least one of the first output device and the second output device included in the output system according to claim 1,
wherein the control program causes a computer to function as any of said parts.

11. (canceled)

12. The character string according to claim 1,
wherein the character string is a keyword.

13. The character string according to claim 9,
wherein the character string is a keyword.
